(19) United States
(12) Patent Application Publication
(10) Pub. No.: US 2008/0133424 A1
(43) Pub. Date: Jun. 5, 2008

(54) System and method for negotiating a contract

(75) Inventors: Gerald L. Myers, Heyworth, IL (US); Matthew S. Kaag, Peoria, IL (US); Douglas C. Meyer, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/605,950

(22) Filed: Nov. 30, 2006

(51) Int. Cl. G06Q 10/00

(52) U.S. Cl. 705/80

(57) ABSTRACT

A system for negotiating a contract may include one or more computer assemblies configured to run a contract negotiation tool program. The contract negotiation tool program may include an analysis section including potential contract terms, and contract term data corresponding to the potential contract terms. The contract negotiation tool program may display the contract term data of selected potential contract terms in the analysis section. The displayed contract term data may include assessments of the selected potential contract terms, providing an indication of whether further negotiation is required.

### TECHNICAL FIELD

The present disclosure relates generally to a system and method for conducting business, and relates more particularly to a system and method for negotiating the terms of a contract.

### BACKGROUND

A business organization may be divided into departments, where each department may specialize in performing a specific task. Generally, large business organizations may include a greater number of departments than small business organizations, and within each of those departments, large business organizations may include a greater number of employees. Due to the size and number of departments, maintaining communication between different departments may prove difficult. As a result, the knowledge possessed by the employees of one department may not be easily passed on to the employees of another department, even if that knowledge would benefit all parties in their duties. This lack of communication may result in mistakes and other inefficiencies that could limit the business organization's performance.

For example, a business organization may include a department that focuses on customer sales. The sales department may offer goods and/or services that may be purchased by customers. The sales department and customers may enter into contract negotiations in the hopes of reaching an agreement as to the manner in which the goods and/or services will be provided. Once the terms of the contract are set, both the business organization and the customers may be required to abide by those terms in the course of their dealings with one another. The business organization may also include a support department, including various support personnel, charged with the task of delivering the goods and/or services to the customer in accordance with the terms of the contract.

Sometimes the contract terms may turn out to be undesirable for the business organization. One of the causes may be that, when negotiating the contract, the sales department may promise delivery of goods and/or services without knowing of or accounting for hidden costs and risks associated with the delivery. As such, the business organization may suffer a loss in trying to deliver the goods and/or services to the customer in accordance with the terms of the contract.

Since support personnel may possess first-hand knowledge of what is required to deliver the goods and/or services, they may be more aware of costs and risks. However, due to a lack of open communication between the two departments, this information may not reach the sales department prior to or during negotiations, thus resulting in the sales department agreeing to unfavorable terms. The ability to provide the sales department with such information may play a key role in ensuring that unfavorable contract terms will not be proposed or accepted.

At least one system has been developed to assist in the negotiation of contracts. For example, U.S. Pat. No. 6,067,531 to Hoyt et al. (“Hoyt”) discloses an automated contract negotiator/generation system and method. Hoyt describes a sharable contract database of editable data defining a contract as a plurality of discrete contract components. Multiple users may access contract data for which they are responsible. The contract data may flow from one user to another, with each user having the ability to modify the contract data and approve it before sending it to the next user. However, because many different users can access and change the contract data, conflicts may arise. For example, users or classes of users may not be aware of the goals/motivations of other users, and thus, they may disagree over the content of the contract data, or may make changes that another user may find undesirable.

The system and method of the present disclosure is directed towards overcoming one or more of the constraints set forth above.

### SUMMARY OF THE INVENTION

In one aspect, the presently disclosed embodiments may be directed to a system for negotiating a contract. The system may include one or more computer assemblies configured to run a contract negotiation tool program. The contract negotiation tool program may include an analysis section including potential contract terms, and contract term data corresponding to the potential contract terms. The contract negotiation tool program may display the contract term data of selected potential contract terms in the analysis section. The displayed contract term data may include assessments of the selected potential contract terms, providing an indication of whether further negotiation is required.

In another aspect, the presently disclosed embodiments may be directed to a method for negotiating a contract using a contract negotiation tool. The method may include analyzing the contract to identify potential contract terms, and selecting the potential contract terms from an analysis section of the contract negotiation tool. The contract negotiation tool may retrieve contract term data corresponding to the selected potential contract terms. The method may also include displaying the contract term data in the analysis section, the displayed contract term data including assessments of the potential contract terms, to provide an indication of whether further negotiation is required.

### BRIEF DESCRIPTION OF THE DRAWINGS

FIG. 1 is a schematic diagram of a system for negotiating a contract according to an exemplary embodiment of the present disclosure.

FIG. 2 is a schematic diagram of a network according to an exemplary disclosed embodiment of the present disclosure.

FIG. 3A is an illustration of a display according to an exemplary embodiment of the present disclosure.

FIG. 3B is an illustration of a display according to another exemplary embodiment of the present disclosure.

FIG. 4 is an illustration of a display according to another exemplary disclosed embodiment of the present disclosure.

FIG. 5 is a flow diagram of a method for negotiating a contract according to an exemplary embodiment of the present disclosure.

### DETAILED DESCRIPTION

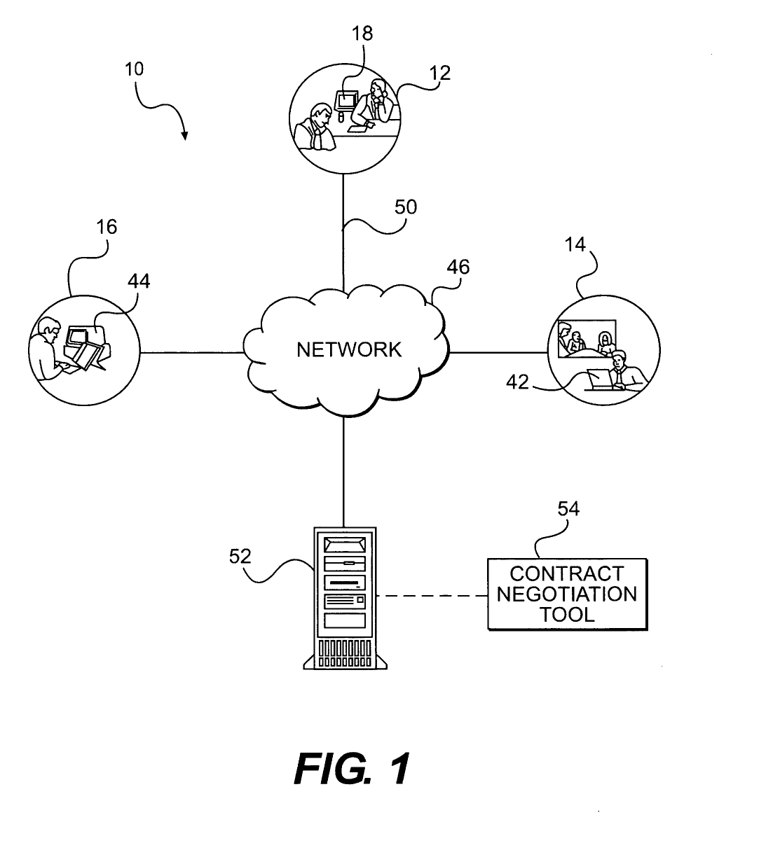

A business organization 10 may include one or more groups, divisions, or departments, each specializing in one or more areas of the business organization's business. For example, as shown in FIG. 1, business organization 10 may include a sales group 12 and a support group 14. Sales group 12 may be responsible for selling products and/or services to a customer 16. In performing this task, sales group 12 may negotiate a contract with customer 16, specifying the terms by which the products and/or services will be provided to customer 16. Support group 14 may be responsible for planning, and for making sure that the products and/or services are provided to customer 16 in accordance with the terms of the contract.

Sales group 12 may bargain with customer 16 in an attempt to create a contract with terms favorable to business organization 10. Once an agreement is reached between sales group 12 and customer 16, and a contract is made, business organization 10 may be obligated to honor the terms of the contract. For example, the terms of the contract may specify that customer 16 may agree to purchase a product and/or service at a set price, so long as the business organization can deliver or otherwise provide the product and/or service according to a specified schedule. If costs associated with delivery exceed the expectations of sales group 12, adhering to the contract terms could result in a loss to business organization 10. Providing complete and accurate information to sales group 12, so that it can accurately predict costs and risks, may play a key role in the prevention of unexpected losses.

Support group 14 may be tasked with planning the business organization's operations, including the process of delivering products and/or services to customer 16. Support group 14 may include, for example, facility managers, logistics specialists, suppliers, technicians, machine operators, and/or other personnel. In a physical sense, there may be relatively little overlap between sales group 12 and support group 14. In some instances, sales group 12 and support group 14 may be staffed by different employees in different locations. However, sales group 12 and support group 14 may be related in some aspects of their operations. For example, while sales group 12 alone may have the responsibility of negotiating and setting the terms of a contract, any agreements between sales group 12 and customer 16 may affect support group 14, because support group 14 must try to provide the products and/or services in accordance with the terms of the contract. Since support group 14 may encounter problems in providing the products and/or services, support group 14 may be aware of hidden costs and risks associated with providing the products and/or services. Providing sales group 12 with such information may benefit business organization 10 overall, as sales group 12 may be able to change the terms of the contract during negotiations to account for those hidden costs and risks.

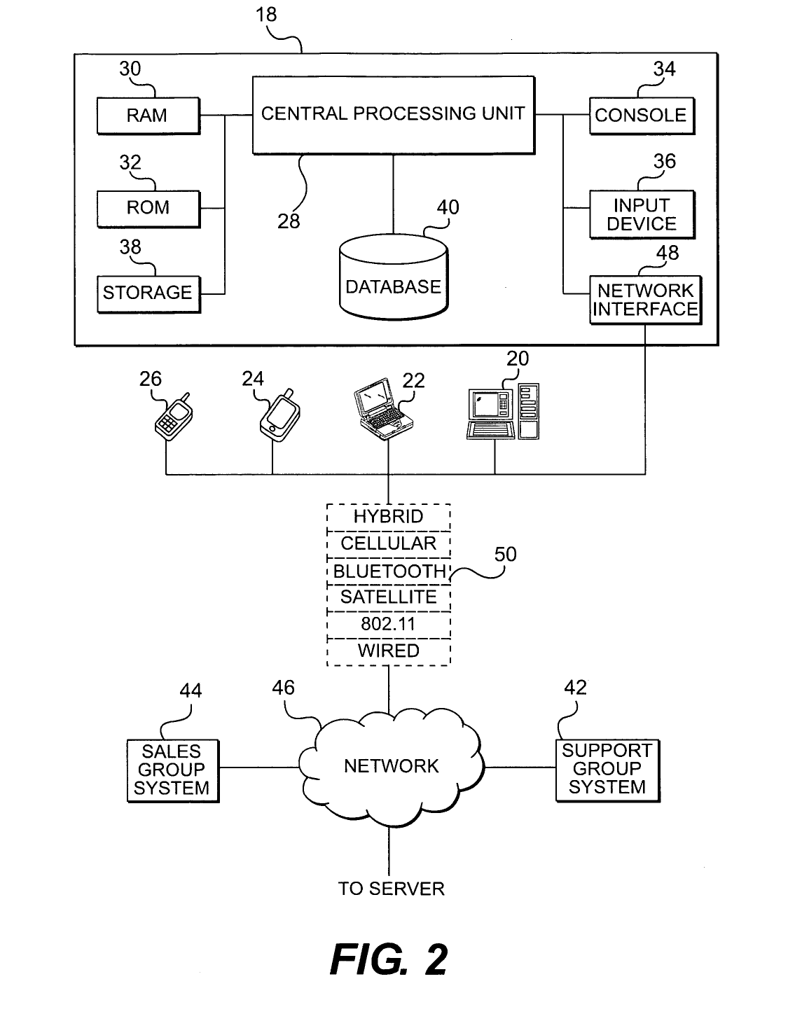

Sales group 12 and support group 14 may communicate with one another through communication systems 18 and 42. Sales group system 18, shown in greater detail in FIG. 2, may include a personal computer 20, laptop 22, personal digital assistant 24, cell phone 26, or any other suitable communication device known in the art. Sales group system 18 may include a central processing unit (“CPU”) 28, a random access memory (“RAM”) 30, a read only memory (“ROM”) 32, a console 34, an input device 36, a network interface 48, a storage device 38, and at least one database 40. It is contemplated that sales group system 18 may include additional, fewer, and/or different components than those listed above. It is understood that the type and number of listed devices are exemplary only and not intended to be limiting.

CPU 28 may execute sequences of computer program instructions to perform various processes that will be explained later. The computer program instructions may be accessed and read from ROM 32, or any other suitable memory location, and loaded into RAM 30 for execution by CPU 28. Depending on the type of sales group system 18 being used, CPU 28 may include one or more printed circuit boards, and/or a microprocessor chip.

Sales group system 18 may be accessed and controlled by a user, such as a sales group employee, using console 34 and input device 36. Console 34 may provide a graphical user interface (“GUI”) to provide information to users of sales group system 18. Additionally, console 34 may include an appropriate computer display device including, for example, a computer screen (not shown). Input device 36 may be provided for users to input information into sales group system 18, and may include, for example, a keyboard, a mouse, and/or optical or wireless computer input devices (not shown). Network interface 48 may provide communication connections such that sales group system 18 may be accessible remotely through computer networks.

Storage 38 may include any type of mass storage suitable for storing information. For example, storage 38 may include one or more hard disk devices, optical disk devices, or any other storage devices that provide data storage space. In one embodiment of the present disclosure, database 40 may store data related to various contract terms. Database 40 may also include analysis and organization tools for analyzing and organizing the information contained therein.

Support group system 42 and a customer system 44 may be similar to sales group system 18. Each system 18, 42, and 44, may be connected to a network 46 by network interface 48 and a communication channel 50 that may include one or more of the following: a satellite data link, cellular telephone communications link, radio link, bluetooth, 802.11, a wired communications link, or any other suitable communication channel known in the art. Additionally or alternatively, customer 16 and sales group 12 may communicate with one another in person.

Network 46 may include, for example, the Internet, which may provide sales group 12, support group 14, and/or customer 16 with the ability to interact with each other from remote locations. According to one aspect of the present disclosure, and as shown in FIG. 1, sales group 12 and support group 14 may access a server system 52 through network 46. Server system 52 may typically include a computer system that operates continuously on network 46 to provide data, including, for example, websites, software, and web-based applications, to other computers on network 46.

Server system 52 may be owned and/or operated by business organization 10, and as such, access to its contents may be limited to sales group 12 and support group 14. Furthermore, within sales group 12 and support group 14, different personnel may have different levels of access depending on the type of information or content they are authorized to view. Access may be regulated using any suitable password application known in the art. Data transferred to and from server system 52 may be protected using encryption software and other protection schemes, as would be apparent to one skilled in the art.

Server system 52 may include one or more software applications, including, for example, a contract negotiation tool 54. Contract negotiation tool 54 may run on server system 52, and may be accessed by support group 14 and sales group 12 via their respective systems 42 and 18 through network 46. It is also contemplated that contract negotiation tool 54 may be stored on a computer readable medium, such as a hard drive, computer disk, CD-ROM, or any other suitable medium, and may run on at least one of sales group system 18 and support group system 42.

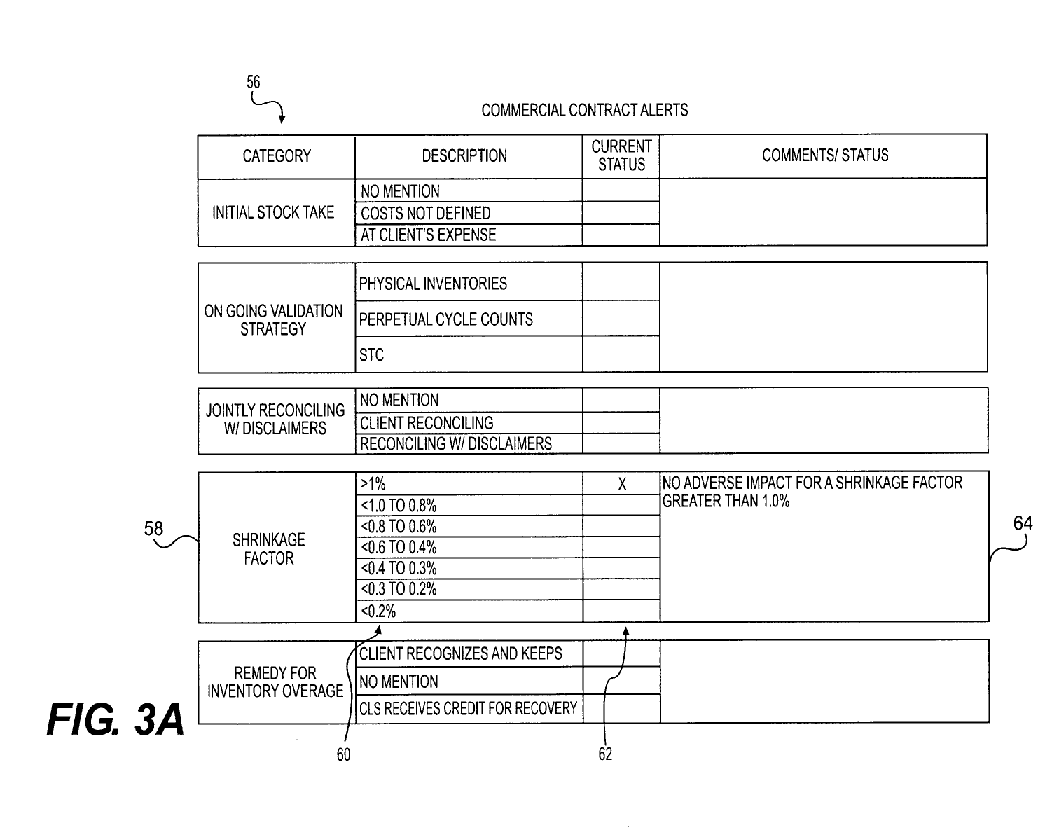

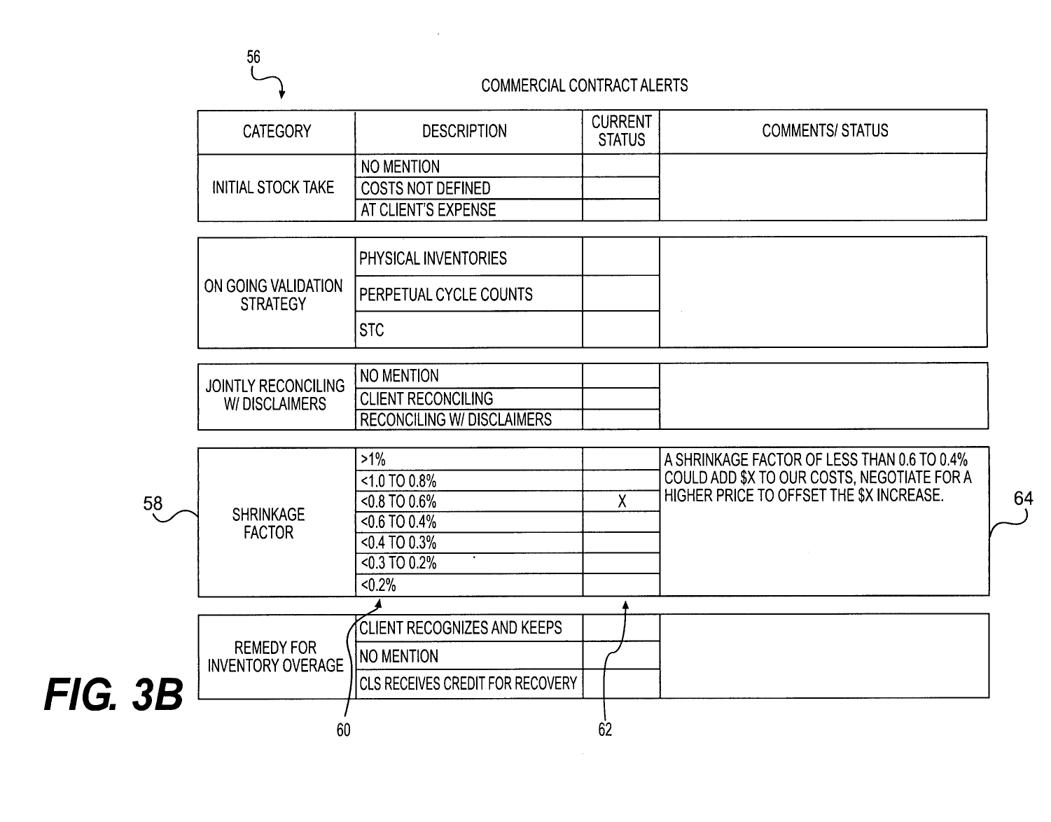

Contract negotiation tool 54 may include one or more sections, in the form of charts, tables, spreadsheets, web pages, templates or any other similar organizational structures, for conveying data to a user and receiving data from the user. For example, contract negotiation tool 54 may include at least one analysis section 56, depicted in FIGS. 3A and 3B as it might appear on console 34. As shown, analysis section 56 may include one or more fields for receiving and displaying data.

The terms of a contract may be chosen from a variety of possible alternatives. In most cases, contract terms may be grouped in one or more general categories. Analysis section 56 may include one or more category fields 58 displaying the general categories. It should be understood that analysis section 56 may include less, more, or different general categories based on the characteristics and needs of business organization 10, customer 16, and the products and/or services being bought and sold.

The general categories may broadly encompass potential contract terms that sales group 12 may add to a potential contract during negotiations with customer 16. Support group 14 may access contract negotiation tool 54 and enter a general category in category field 58 via support group system 42. Support group 14 may change or update category field 58 to adapt contract negotiation tool 54 for use with new customers or in new areas of business.

Analysis section 56 may also include one or more description fields 60. Description fields 60 may be associated with category field 58 in that description fields 60 may display the potential contract terms that fall under the general category in category field 58. Support group 14 may enter the potential contract terms into description fields 60. It should be understood that support group 14 may add, delete, or alter description fields 60 when appropriate, such as, for example, if the business environment changes.

Analysis section 56 may also include one or more current status fields 62, each corresponding to one of description fields 60. The presence of a visual indicator, such as an “X”, in current status fields 62 may be indicative of the presence, in the potential contract, of the corresponding potential contract terms in description fields 60. Support group 14 may assign a risk value and a profit value to each of current status fields 62. The risk value, which may or may not be displayed, may be indicative of the level of risk associated with including a potential contract term in a final contract. The profit value, which may or may not be displayed, may be indicative of the expected profit associated with including the potential contract term in the final contract. In one embodiment, the risk values and profit values assigned to current status fields 62 may be selected from a predetermined set of numbers, including, for example, one, zero, or negative one. However, it should be understood that the risk values and profit values may include any other suitable numbers and/or value indicators.

Sales group 12 may select current status fields 62 by, for example, placing visual indicators in current status fields 62. For example, during contract negotiations, sales group 12 may consider placing one or more potential contract terms in the final contract. In order to determine the desirability of the potential contract term, sales group 12 may access contract negotiation tool 54 through sales group system 18. Sales group 12 may select current status fields 62 that correspond to the potential contract terms. It is contemplated that sales group 12 may select current status fields 62 by typing an “X” therein; by clicking within areas defined by current status fields 62 using a mouse or stylus (not shown), causing visual indicators to appear in current status fields 62; or by any other suitable manner known in the art. Once the appropriate current status fields 62 have been selected by sales group 12, the risk values and profit values associated with the selected current status fields 62 may be automatically entered into another section of contract negotiation tool 54, which will be described subsequently in greater detail.

Comment field 64 may also be provided, and may correspond to category field 58 and description fields 60. Comment field 64 may display comments that further describe or explain the general categories in category field 58 and/or potential contract terms listed in description fields 60. It is contemplated that support group 14 may enter comments into comment field 64. It is also contemplated that comment field 64 may selectively display comments based on which of current status fields 62 is selected by sales group 12. For example, comment field 64 may remain blank until one of current status fields 62 is selected. Each of current status fields 62 may have associated with it a particular comment or group of comments. Selecting a particular one of current status fields 62 may cause comments to be displayed in comment field 64. FIG. 3A shows comments in comment field 64 when one of current status fields 62 is selected. FIG. 3B shows comments in comment field 64 when another of current status fields 62 is selected.

Support group 14 may include one or more employees. In business organizations with large support groups, different employees in those support groups may be provided with different levels of access to analysis section 56 of contract negotiation tool 54. For example, lower level employees use of contract negotiation tool may be limited to viewing analysis section 56. Higher level employees may be able to modify category field 58, description fields 60, and comment field 64 of analysis section 56, but may be limited in their ability to alter the overall structure and operation of analysis section 56. At an even higher level of access, an employee may have the ability to modify every aspect of analysis section 56. The number of levels and the characteristics of the levels of access provided to the employees may be selectively regulated using a password application or any other suitable protection scheme known in the computer art.

Keeping analysis section 56 current may be critical in ensuring that contract negotiation tool 54 remains accurate. As such, contract negotiation tool 54 may send an e-mail, page, or other alert to support group 14 if information contained in analysis section 56 has become obsolete. Additionally or alternatively, contract negotiation tool 54 may send the e-mail or alert after a predetermined amount of time has passed without an update having been performed on contract negotiation tool 54. The e-mail or alert may be sent to one or more employees in support group 14, and in particular, those employees having the level of access required to update analysis section 56.

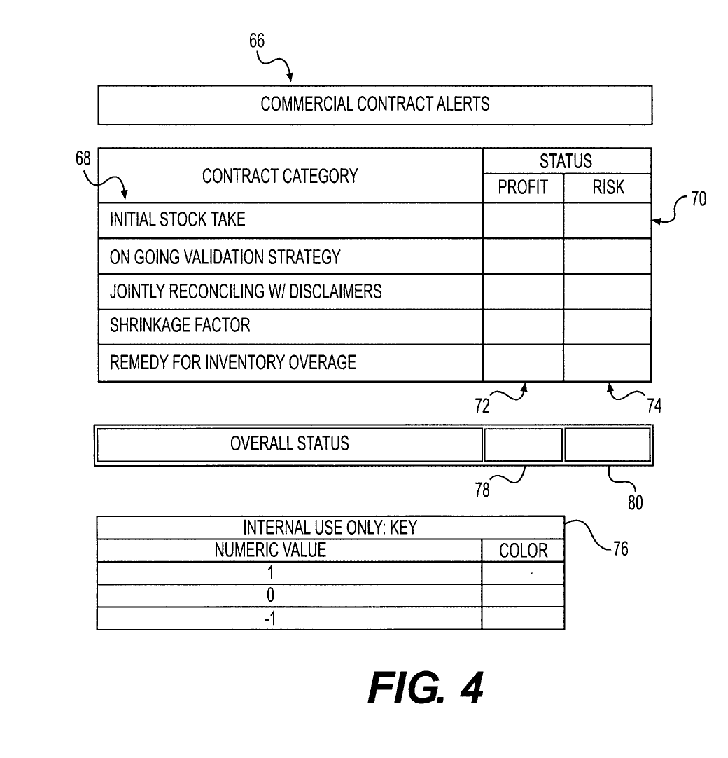

A summary section 66 of contract negotiation tool 54 is shown in FIG. 4 as it might appear on console 34. Summary section 66 may organize the information from analysis section 56, perform calculations, and present the information in summarized form. At least some of the information entered into analysis section 56 may be automatically transferred to summary section 66. For example, summary section 66 may include one or more category fields 68 corresponding to category fields 58 in analysis section 56. Contract negotiation tool 54 may automatically enter the general categories into category fields 68 when the general categories are entered by support group 14 in category fields 58.

Summary section 66 may also include one or more status fields 70 corresponding to category fields 68. Status fields 70 may be divided into two columns, thus dividing each of status fields 70 into two fields. These two fields may include profit fields 72 and risk fields 74. When current status fields 62 are selected in analysis section 56, profit values associated with the selected current status fields 62 may be automatically entered into profit fields 72 corresponding to those current status fields 62.

Visual indicators may be generated in profit fields 72 based on the magnitude of the profit values entered therein. As shown in key 76, the color green may be generated in profit fields 72 that receive profit values of “1” from current status fields 62. The color yellow may be generated in profit fields 72 that receive profit values of “0” from current status fields 62. The color red may be generated in profit fields 72 that receive profit values of “−1” from current status fields 62. It is also contemplated that the visual indicators may include shading, hatching, text effects (e.g. bolding, underlining, and/or italicizing) or any other suitable visual indicators in place of or in addition to the coloring. While only three values are shown in key 76, any other values or ranges of values may be used. The values and visual indicators in profit fields 72 may be indicative of the level or degree of profitability associated with certain potential contract terms.

Visual indicators may be generated in risk fields 74 based on the magnitude of the risk values entered therein. The characteristics of risk fields 74 may be similar to those of profit fields 72 described above, except that risk fields 74 may automatically receive the risk values from current status fields 62. The numerical values and visual indicators in risk fields 74 may be indicative of the level or degree of risk associated with the selected potential contract terms.

Summary section 66 may also include an overall status field, divided into an overall profit field 78 and an overall risk field 80. Profit values in profit fields 72 may be averaged, and the average profit value may be automatically entered into overall profit field 78. Risk values in risk fields 74 may also be averaged, with the average risk value being automatically entered into overall risk field 80. Once the values are entered into overall profit field 78 and overall risk field 80, a visual indicator, similar to that described above with respect to profit fields 72 and risk fields 74, may be generated in overall profit field 78 and overall risk field 80.

It is contemplated that contract negotiation tool 54 may include a plurality of analysis sections, each one being geared toward a particular type of contract, customer, or business environment. Sales group 12 may locate the analysis section corresponding to a potential contract, and then select the current status fields that correspond to the potential contract being negotiated. When a different type of potential contract is negotiated, sales group 12 may select a different analysis section.

Additionally or alternatively, analysis section 56 may contain blank fields, and server system 52 may store data in one or more databases that may be used to fill in the blank fields. When using contract negotiation tool 54, sales group 12 may be asked to identify the type of contract being negotiated by, for example, choosing from a list of standard contract forms, selecting a customer from a list of customers, and/or choosing from a list of goods and/or services being offered. Once the contract type is identified, contract negotiation tool 54 may retrieve data from the databases, including the general categories, potential contract terms, and comments, related to the identified contract type. Contract negotiation tool 54 may automatically insert the retrieved data into the blank fields of analysis section 56.

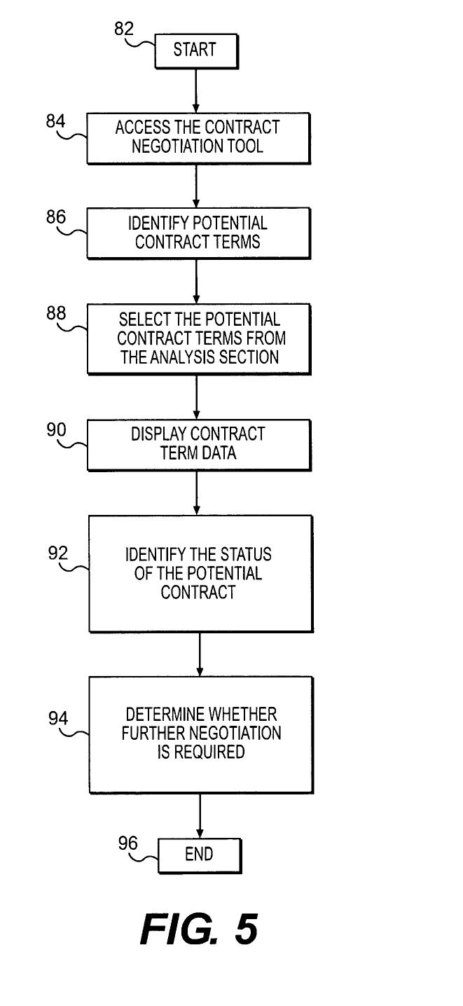

One embodiment of a method for negotiating a contract is shown in FIG. 5. Initially, as previously described, support group 14 may access analysis section 56 of contract negotiation tool 54 to enter data, and/or update previously entered data, in category fields 58, description fields 60, current status fields 62, and/or comment fields 64, of analysis section 56. By doing so, support group 14 may help to ensure that the information contained in analysis section 56 may be current. Once the information is current and accurate, sales group 12 may use contract negotiation tool 54 to negotiate the contract.

The method may start (step 82) with sales group 12 accessing contract negotiation tool 54 (step 84), using sales group system 18, during negotiations with customer 16. Sales group 12 may identify potential contract terms contained in a potential contract (step 86). Sales group 12 may select the potential contract terms from analysis section 56 (step 88). Contract negotiation tool 54 may automatically transfer data, including profit values and risk values, from analysis section 56 into summary section 66. Contract negotiation tool 54 may also automatically perform calculations involving the profit values and risk values, including, for example, determining an average profit value and an average risk value for each of the general categories, based on the potential contract terms selected in analysis section 56. Contract negotiation tool 54 may display the profit values, risk values, average profit value, average risk value, and/or another other contract term data to sales group 12 (step 90). Displaying the data may include, for example, generating visual indicators in profit fields 72, risk fields 74, overall profit field 78, and overall risk field 80, according to the values contained therein.

Based on the values and/or visual indicators in profit fields 72, risk fields 74, overall profit field 78, and overall risk field 80, sales group 12 may identify and determine the status of the potential contract (step 92), and sales group 12 may determine whether further negotiation is necessary (step 94). For example, sales group 12 may determine whether to modify or fix (e.g., change, replace, or remove) undesirable potential contract terms. Sales group 12 may also adjust the pricing, quality, and/or quantity of goods and/or services to compensate for costs and risks. By modifying the potential contract terms, sales group 12 may ensure that the final contract terms may be acceptable. Sales group 12 may also elect to proceed with forming a contract, even though certain terms may be undesirable, to help develop relationships with customers, offer discounts, or for any other suitable reason. Afterwards, the method may end (step 96).

It is contemplated that multiple sales groups and support groups (not shown) may access and use contract negotiation tool 54 simultaneously over network 46. Each support group may be responsible for entering data for one or more analysis sections. Each sales group may only access those analysis and summary sections related to its operations. Thus, contract negotiation tool 54 may serve as a communication channel between an entire network of groups, divisions, or departments, within business organization 10, while also acting as a safe source of contract information.

### INDUSTRIAL APPLICABILITY

The disclosed system and method for negotiating a contract may have applicability in a business organization 10 that conducts business with one or more customers 16.

The system may include a contract negotiation tool 54. Contract negotiation tool 54 may receive user inputs, perform calculations, and visually quantify profit and risk with respect to various potential contract terms. By visually coding fields in a summary section 66 of contract negotiation tool 54, a user, such as a sales group 12, may identify potential contract terms that may be unfavorable for business organization 10. Upon identifying unfavorable potential contract terms, sales group 12 may be able to modify, delete, or replace the potential contract terms, so that the resulting contract between business organization 10 and customer 16 may be more favorable.

Contract negotiation tool 54 may also serve as a communication channel between sales group 12 and a support group 14. Generally, in business organization 10, sales group 12 may offer goods and/or services to customer 16. Sales group 12 and customer 16 may negotiate a contract specifying how the goods and/or services will be provided. Support group 14 may be charged with the task of providing the goods and/or services to the customer, and thus, support group 14 may have knowledge concerning providing those goods and/or services that may go above and beyond the knowledge possessed by sales group 12. Support group 14 may communicate that knowledge by entering it into an analysis section 56 of contract negotiation tool 54. By accessing and using contract negotiation tool 54, and in particular, analysis section 56, sales group 12 may utilize the knowledge from support group 14 before or during negotiations to avoid unfavorable contract terms.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A system for negotiating a contract, comprising:
one or more computer assemblies configured to run a contract negotiation tool program, wherein the contract negotiation tool program includes:
an analysis section including potential contract terms; and
contract term data corresponding to the potential contract terms, wherein:
the contract negotiation tool program displays the contract term data of selected potential contract terms in the analysis section; and
the displayed contract term data includes assessments of the selected potential contract terms, providing an indication of whether further negotiation is required.

2. The system of claim 1, wherein the contract term data includes profit values indicative of potential profit associated with the potential contract terms, and risk values indicative of potential risk associated with the potential contract terms.

3. The system of claim 2, wherein displaying the contract term data includes displaying the profit values in profit fields in a summary section of the contract negotiation tool program, and displaying risk values in risk fields in the summary section.

4. The system of claim 3, wherein displaying the contract term data further includes:
generating visual profit indicators in the profit fields based on the profit values displayed therein; and
generating visual risk indicators in the risk fields based on the risk values displayed therein;
wherein the visual profit indicators are indicative of potential profitability, and the visual risk indicators are indicative of potential risk.

5. The system of claim 2, wherein displaying the contract term data includes displaying an overall profit value in an overall profit field in a summary section of the contract negotiation tool program, and displaying an overall risk value in an overall risk field in the summary section.

6. The system of claim 5, wherein displaying the contract term data further includes:
generating a visual profit indicator in the overall profit field based on the overall profit value displayed therein; and
generating a visual risk indicator in the overall risk field based on the overall risk value displayed therein;
wherein the visual profit indicator is indicative of potential profitability, and the visual risk indicator is indicative of potential risk.

7. The system of claim 5, wherein the contract negotiation tool program is configured to calculate the overall profit value by taking an average of the profit values of the selected potential contract terms.

8. The system of claim 5, wherein contract negotiation tool program is configured to calculate the overall risk value by taking an average of the risk values of the selected potential contract terms.

9. The system of claim 1, wherein the one or more computer assemblies is part of a computer network, and is configured to selectively restrict access to the contract negotiation tool program.

10. The system of claim 1, wherein the analysis section further includes a list of contract term categories, each contract term category including a plurality of potential contract terms.

11. The system of claim 10, wherein the analysis section further includes:
one or more current status fields configured to display visual indicators when potential contract terms are selected; and
one or more comment fields configured to display user comments.

12. The system of claim 10, wherein a summary section of the contract negotiation tool program includes the list of contract term categories.

13. A method for negotiating a contract using a contract negotiation tool, the method comprising:
identifying potential contract terms;
selecting the potential contract terms from an analysis section of the contract negotiation tool, wherein the contract negotiation tool retrieves contract term data corresponding to the selected potential contract terms; and
displaying the contract term data in the analysis section, the displayed contract term data including assessments of the potential contract terms, to provide an indication of whether further negotiation is required.

14. The method of claim 13, wherein the contract term data includes profit values indicative of potential profit associated with the potential contract terms, and risk values indicative of potential risk associated with the potential contract terms.

15. The method of claim 14, wherein the profit values are displayed in profit fields in a summary section of the contract negotiation tool program, and risk values are displayed in risk fields in the summary section.

16. The method of claim 15, wherein displaying the contract term data further includes:
generating visual profit indicators in the profit fields based on the profit values displayed therein; and
generating visual risk indicators in the risk fields based on the risk values displayed therein;
wherein the visual profit indicators are indicative of potential profitability, and the visual risk indicators are indicative of potential risk.

17. The method of claim 14, wherein displaying the contract term data includes displaying an overall profit value in an overall profit field in a summary section of the contract negotiation tool program, and displaying an overall risk value in an overall risk field in the summary section.

18. The method of claim 17, wherein displaying the contract term data further includes:
generating a visual profit indicator in the overall profit field based on the overall profit value displayed therein; and
generating a visual risk indicator in the overall risk field based on the overall risk value displayed therein;
wherein the visual profit indicator is indicative of potential profitability, and the visual risk indicator is indicative of potential risk.

19. The method of claim 17, wherein the overall profit value is calculated by taking an average of the profit values.

20. The method of claim 17, wherein the overall risk value is calculated by taking an average of the risk values.
